(19) United States
(12) Patent Application Publication
(10) Pub. No.: US 2020/0327794 A1
(43) Pub. Date: Oct. 15, 2020

(54) Device adapted to detect the presence of a child in a car seat and to generate an emergency warning

(71) Applicant: CF3000 - S.R.L., REGGIO EMILIA (IT)

(72) Inventors: Flavio CORRADINI, REGGIO EMILIA (IT); Luca CORRADINI, REGGIO EMILIA (IT)

(21) Appl. No.: 16/761,932

(22) PCT Filed: Nov. 2, 2018
(86) PCT No.: PCT/IB2018/058607

§ 371 Date: May 6, 2020

(30) Foreign Application Priority Data
Nov. 6, 2017 (IT) 102017000125901

(51) Int. Cl. G08B 21/22; B60N 2/28; G08B 21/24

(52) U.S. Cl. CPC G08B 21/22; G08B 21/24; B60N 2/28

(57) ABSTRACT

A device (10) adapted to detect the presence of a child in a car seat (20) and to generate an emergency warning, is proposed. The device (10) comprises: a sensor arrangement (30, 70) that can be operatively coupled to the car seat (20), the sensor arrangement (30) being adapted to detect a body interacting therewith and to generate a signal indicative of the detection thereof; a communication arrangement (40) comprising a transmitter module (43) coupled to the sensor arrangement (30) and a receiver module (43) that can be coupled to a communication interface (61) of a vehicle (60) on which the car seat (20) is mounted, and an energy arrangement (50, 70) operatively connected to the sensor arrangement (30) and to the transmitter module (43) of the communication arrangement (40) and suitable for providing electric energy thereto.

### TECHNICAL FIELD

The present invention relates to a safety device for vehicles, in particular a car. More specifically, the present invention relates to a device adapted to detect the presence of a child in a car seat and to generate an emergency warning.

### EXISTING TECHNIQUE

As it is known, forgetting a child in a car seat inside a vehicle may have very serious consequences, up to the death of the child due to heat stroke due to the rising internal temperature of the vehicle, also in the case of a contained temperature of the external environment.

Certain devices for signalling a child who stayed in the car after the vehicle is stopped have been proposed in the art.

For example, there have been proposed car seats and devices that can be coupled with car seats comprising detectors, signalling units and/or telecommunication arrangements for detecting the presence of a child in a seat and signalling it to a driver of the vehicle and/or to rescuers.

However, such solutions require a wiring with a supply circuit of the vehicle for receiving an operating energy and/or a wiring with a supply circuit of the vehicle. The use of such solutions involves a mounting and dismounting step each time the seat is positioned in or removed from the vehicle. This prolongs the times required to undertake a movement with the vehicle and results in the possibility of error in mounting the car seat, with a subsequent possible inefficiency of the solution. Additionally, the connection between such devices and the supply circuit may result in the risk of electric shocks for those who come in contact with the device in the case of an improper mounting or of a malfunction condition of the device on the car seat.

Moreover, telecommunication and tracking systems (for example, cellular models, GPS modules, etc.) significantly increase a complexity and cost of such solutions and require a non-negligible quantity of energy for the correct operation thereof. At the limit, such systems cannot be supplied by the supply circuit of the car, but require independent battery units which substantially have an effect on a volume and weight of the solutions. Moreover, the use of battery units involves periodic control, maintenance and recharging operations thereof before each trip.

Moreover, the existing devices do not allow an easy interface with the vehicle, in particular with electronic control units or ECUs of the vehicle, for receiving data therefrom, for example information of vehicle status (such as the powering down of the vehicle), and for transmitting warning signals which result in the actuation of one or more electromechanical apparatuses of the vehicle.

It is an object of the present invention to overcome the mentioned drawbacks of the known technique within the scope of a simple, rational and affordable solution.

Such objects are achieved by the features of the invention indicated in the independent claim. The dependent claims outline preferred and/or particularly advantageous aspects of the invention.

### DESCRIPTION OF THE INVENTION

The invention particularly makes available a device adapted to detect the presence of a child in a car seat and to generate an emergency warning. The device comprises: a sensor arrangement that can be operatively coupled to the car seat, the sensor arrangement being adapted to detect a body interacting therewith and to generate a signal indicative of the detection thereof; a communication arrangement comprising a transmitter module coupled to the sensor arrangement and a receiver module that can be coupled to a communication interface of a vehicle on which the car seat is mounted, and an energy arrangement operatively connected to the sensor arrangement and to the transmitter module of the communication transmitter unit and suitable for providing electric energy thereto.

Thanks to such solution, there is obtained a device which is compact and substantially energy-independent from a supply system of the vehicle on which the car seat is mounted, i.e. it does not require a supply wiring with the supply system of the vehicle.

In one embodiment, the energy arrangement comprises an electric battery.

Thereby, the device may remain operational so long as the electric battery may provide an electric energy sufficient for the operation of the device. In one embodiment, the energy arrangement comprises an energy harvesting module, also known as power harvesting module.

Thanks to such solution, it is possible to acquire electric energy suitable for the operation of the device without turning to a source of electric energy external to the device.

In one embodiment, the energy harvesting module is operatively connected to the electric battery to provide electric energy thereto.

Thereby, the electric battery may be recharged during the use of the device without the need to turn to a source of electric energy external to the device.

In one embodiment, the energy harvester comprises a piezoelectric element.

Thanks to such solution, it is possible to generate electric energy starting from mechanical stresses, such as vibrations and body movements, to which the device is subjected.

In one embodiment, the energy arrangement and the sensor arrangement correspond. Preferably, an electric energy generated by the piezoelectric element of the energy harvester indicates a body interacting therewith.

Thereby, a particularly compact and simple, but at the same time substantially autonomous and efficient, device is obtained.

In one embodiment, the device further comprises a flat support having a surface corresponding to a seat of the car seat. Preferably, the sensor arrangement and the piezoelectric element are integrated in the support.

Thanks to such solution, it is possible to detect the presence of the body and at the same time to generate electric energy in an efficient and simple and affordable manner.

In one embodiment, the energy harvester comprises a photovoltaic element.

Thanks to such solution, it is possible to generate electric energy for the device starting from the light radiated by the photovoltaic element. In one embodiment, the transmitter module is suitable for transmitting radiofrequency signals to the receiver module.

Thereby, the car seat may be removed from the vehicle in a simple and immediate manner, in particular without requiring dismounting the device or uncoupling the device and the communication interface of the vehicle.

Preferably, the receiver module can be stably connected to the vehicle. For example, the receiver module may be connected to the circuitry of the vehicle by means of the OBD diagnostic port thereof or by means of a wiring, preferably protected by a specific fuse, so as to receive a supply energy from a battery of the vehicle.

Thereby, it is possible to arrange and supply the receiver module in a simple manner without requiring substantial modifications to the vehicle.

In one embodiment of the present invention, the receiver module comprises an acoustic indicator. Preferably, the receiver module is configured to actuate the acoustic indicator following the receipt both of a warning signal transmitted by the transmitter module and a vehicle power-down signal provided by an electronic control unit of the vehicle.

Thanks to such solution, it is possible to generate a signalling in an independent manner from the equipment of the vehicle.

In one embodiment, the receiver module is configured to generate an emergency warning command and to send such command to an element of the vehicle through the communication interface thereof following the receipt both of the warning signal and of the vehicle power-down signal.

Thanks to such solution, the device may impose the actuation of elements of the vehicle to provide an emergency warning to a driver of the vehicle.

In one embodiment, the receiver module is configured to delay, by a predetermined time interval, sending the emergency warning command and/or actuating the acoustic indicator starting from the receipt of the vehicle power-down signal.

Thanks to such solution, it is possible to provide the emergency warning and/or the acoustic signalling in a more efficient manner. In other words, the emergency warning and/or the acoustic signalling are actuated after a period of time has expired after which the probability of forgetting a child in the car seat is high.

In one embodiment, the emergency command comprises at least one among: an actuation command of a lamp of the vehicle; actuating an acoustic indicator of the vehicle; an actuation command of a window winder for opening a window of the vehicle, and an actuation command of a ventilation system of the vehicle.

Thanks to such solution, measures are implemented such as to attract the attention of the driver of the vehicle or of passers-by and preferably, to implement measures for reducing an internal temperature of the vehicle.

It is a further object of the present invention to provide a car safety device suitable for being installed, preferably in a removable manner, on car seats of any type. Advantageously, the device according to the present invention is suitable for being used with car seats already available on the market, although nothing prohibits manufacturing a car seat integrating the device according to embodiments of the present invention.

### BRIEF DESCRIPTION OF THE DRAWINGS

Further features and advantages of the invention will be more apparent after reading the following description provided by way of a non-limiting example, with the aid of the accompanying drawings.

FIG. 1 is a block diagram of a device according to one embodiment of the present invention.

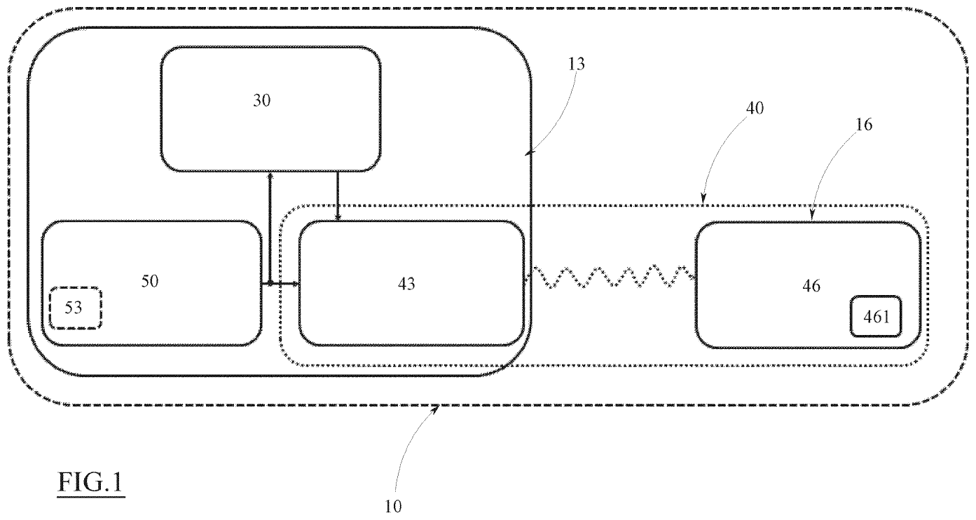

FIG. 2 is a block diagram of the device of FIG. 1, coupled to a car seat in a vehicle.

FIG. 3 is a diagrammatic view of a car seat to which a support is coupled in which there is integrated a seat component of the device according to embodiments of the present invention.

FIG. 4 is a block diagram of a device according to an alternative embodiment of the present invention.

### IMPROVED METHOD FOR IMPLEMENTING THE INVENTION

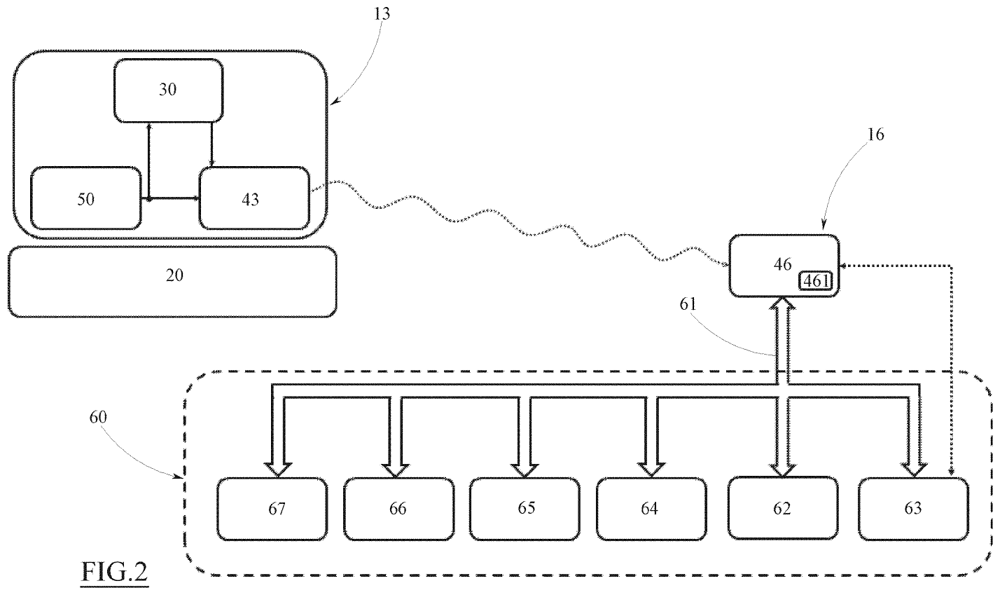

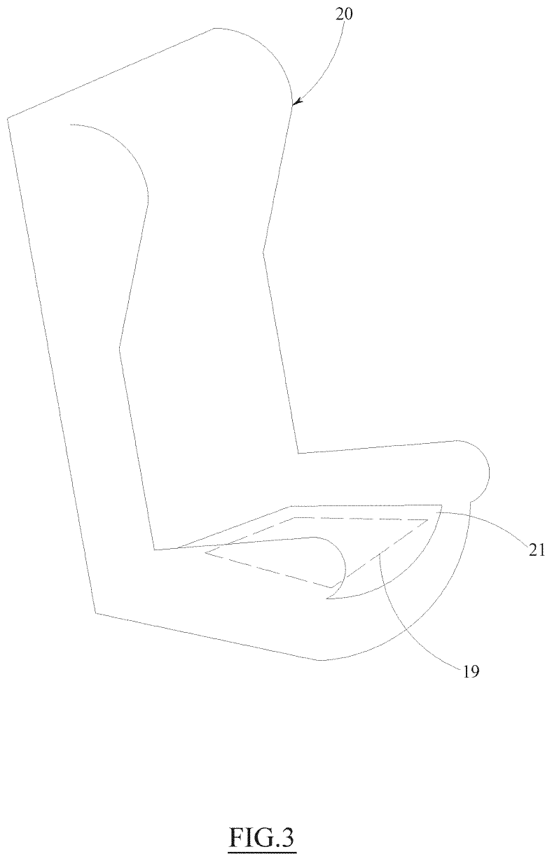

With particular reference to such drawings, a device adapted to detect the presence of a body, in particular a child (not illustrated), in a car seat, illustrated diagrammatically in FIGS. 2 and 3 and indicated with numeral 20, and to generate an emergency warning, is indicated globally with 10.

In the solution according to embodiments of the present invention, the device comprises a sensor arrangement 30 that can operatively be coupled to the car seat 20, a communication arrangement 40 and an energy arrangement 50 operatively connected to the sensor arrangement 30 and to the communication arrangement 40.

In detail, the sensor arrangement 30 is adapted to detect a body interacting therewith and to generate a signal Sr indicative of the detection of the body. The communication arrangement 40 can be coupled to a communication interface, a BUS 61 (Binary Unit System), of the vehicle 60 on which the car seat 20 is mounted. For example, the BUS 61 of the vehicle 60 is a CAN (Controller Area Network) or LIN (Local Interconnect Network) type BUS. Preferably, the communication arrangement 40 is suitable for exchanging signals with electronic control units such as an engine control unit 62, or various ECUs (Electronic Control Units) 64 to 67 of the vehicle 60, through the BUS 61. Finally, the energy arrangement 50 is suitable for providing electric energy to the sensor arrangement 30 and to the communication arrangement 40. In particular, the energy arrangement 50 provides electric energy to a transmitter module 43 thereof.

In one embodiment according to the present invention, the sensor arrangement 30 comprises a pressure sensor. Preferably, the pressure sensor may be implemented by means of a pressure switch. For example, the sensor arrangement 30 comprises a detection surface which compression, due to the application of a greater pressure than a threshold pressure thereon, causes the closing of an electric circuit of the sensor arrangement.

Advantageously, the device 10 may be implemented so that the pressure sensor operates like an actuation switch for the device 10. For example, the device 10 may be implemented so that the closing of the pressure sensor of the sensor arrangement 30 allows a transfer of energy from the energy arrangement 50 to the remaining units of the device 10. Vice versa, the opening of the pressure sensor of the pressure unit 30 prevents a transfer of energy from the energy arrangement 50 to the remaining units of the device 10. Such implementation of the device 10 allows saving electric energy during periods of inactivity (that is when a body is not detected).

Additionally, the sensor arrangement 30 comprises a sensor circuitry suitable for generating the detection signal when the pressure sensor detects a greater pressure than the threshold pressure. Preferably, the sensor circuitry is suitable for receiving electric energy from the energy arrangement 50 for the operation of the sensor arrangement 30. For these purposes, the sensor circuitry comprises respective suitably interconnected active and/or passive electric/electronic components.

However, nothing prevents implementing a sensor arrangement comprising a different sensor as an alternative or in addition to the pressure sensor described above, such as for example one or more extensometers and/or piezoresistive sensors.

In one embodiment according to the present invention, the communication arrangement 40 comprises a transmitter module 43 and a receiver module 46.

The transmitter module 43 is suitable for receiving the indicative signal Sr from the sensor arrangement 30 and for transmitting a corresponding warning signal Sa to the receiver module 46. The receiver module 46 is suitable for receiving the warning signal Sa from the transmitter module 43 and for exchanging signals with the vehicle 60, in particular with the electronic control units 62, 64 to 67 of the vehicle 60. Advantageously, the receiver module 46 is suitable for receiving at least one vehicle power-down signal Sv provided by the engine control unit 62 of the vehicle 60 and for transmitting control signals C (as described below) to one or more of the electronic control units 62, 64 to 67 of the vehicle 60.

In detail, the transmitter module 43 is operatively coupled with the sensor arrangement 30 and the energy arrangement 50; contrarily, the receiver module 46 is separate from the sensor arrangement 30, from the energy arrangement 50 and from the transmitter module 43 while it can be coupled to the BUS 61 of the vehicle 60.

For example, the receiver module 46 may comprise a connector (not shown) of OBD type (On-Board Diagnostic) for being connected to a corresponding connector (not shown) of the vehicle 60 for exchanging signals with the electronic control units of the vehicle. Additionally or alternatively, the receiver module 46 may be connected to the BUS 61 to exchange signals with the electronic control units 62, 64 to 67 of the vehicle 60 through a coupling to cables of the BUS 61 contained in a console of the vehicle 60.

Additionally, the receiver module 46 is suitable for being connected to an energy supply circuit 63 of the vehicle 60 for receiving a respective supply energy. For example, the receiver module 46 may be connected to the energy supply circuit 63 by means of the OBD connector mentioned above or by means of a dedicated connection (indicated by a dotted line in FIG. 2).

For example, the receiver module 46 may be supplied by means of the OBD connector, generally present on modern vehicles, which comprises two wires for the connection to the energy supply circuit 63 of a device connected thereto; here, the receiver module 46 and two wires for communication by means of the BUS 61 with the electronic control units 62 and 64 to 67 of the vehicle 60.

Additionally or alternatively, the receiver module 46 may be connected to the BUS 61 through a coupling to cables of the BUS 61 contained in a console of the vehicle. This is particularly advantageous in the case in which one or more electronic control units 62 and 64 to 67 are not accessible through the OBD connector. An expert in the field will also understand that a supply wiring may be created through a coupling to supply cables comprised within the console of the vehicle 60, in particular where the fuse box lies.

Differently, the transmitter module 43 is connected to the energy arrangement 50 to receive a respective supply energy. For these purposes, the transmitter module 43 and the receiver module 46 comprise a transmitter circuitry and a receiver circuitry, respectively, comprising respective suitably interconnected active and/or passive electric/electronic components.

As mentioned above, the receiver module 46 is a separate and distinct entity from the transmitter module 43. Advantageously, the transmitter module 43 and the receiver module 46 are suitable for transmitting and receiving, respectively, the warning signal Sa by means of a transmission of radiofrequency signals (i.e. electromagnetic waves) or a wireless transmission, for example by means of a transmission according to the Wi-Fi or Bluetooth standards. In other words, the transmitter module 43 transmits the warning signal Sa as a radiofrequency signal, to the receiver module 46.

Preferably, the receiver module 46 comprises an acoustic indicator 461, such as for example a buzzer.

However, in alternative embodiments (not illustrated), the communication arrangement may comprise the transmission module 43 alone adapted to transmit signals directly to a receiver possibly integrated in the vehicle 60.

In one embodiment according to the present invention, the energy arrangement 50 comprises an electric battery 53. Preferably, the electric battery 53 is of the rechargeable type. Even more preferably, the electric battery 53 is a lithium-ion battery (or li-ion battery) or a lithium-iron phosphate battery (LFP). Additionally, the energy arrangement comprises a supply circuitry suitable for electrically connecting the electric battery 53 to the sensor arrangement 30 and to the communication arrangement. In the example considered in the drawings, the supply circuitry electrically connects the electric battery 53 to the transmitter module 43 of the communication arrangement 40. Possibly, the supply circuitry is suitable for adjusting voltage and current values provided to the sensor arrangement 30 and to the transmitter module 43 of the communication arrangement.

Advantageously, the energy arrangement 50 further comprises an energy harvesting module 56.

Preferably, the energy harvesting module 56 is operatively connected to the electric battery 53 to provide electric energy thereto. For example, the energy harvesting module 56 comprises a harvesting circuitry for electrically connecting the energy harvesting module 56 to the electric battery 53. Additionally or alternatively, the energy harvesting module 56 may be operatively connected also to the sensor arrangement 30 and/or to the transmitter module 43 of the communication arrangement 40 to directly provide electric energy thereto.

In a preferred embodiment, the energy harvesting module 56 comprises a piezoelectric element (not shown in the drawings). For example, the piezoelectric element may comprise piezoelectric crystals and/or polymers capable of generating electric energy when mechanically stressed. Additionally, the harvesting circuitry is suitable for receiving the electric energy generated by the piezoelectric element, stabilizing and adjusting the same for the exploitation by the electric battery 53 or by part of the sensor arrangements 30 and/or communication arrangements 40.

Alternatively or additionally, the energy harvester 56 may comprise other electric energy generating elements. In one embodiment, the energy harvester 56 may comprise a photovoltaic element (not shown). For example, the photovoltaic element comprises one or more photovoltaic panels and the harvesting circuitry is suitable for receiving the electric energy generated by the photovoltaic panel, stabilizing and adjusting the same for the exploitation by the electric battery 53 or by part of the sensor arrangements 30 and/or communication arrangements 40. For example, the photovoltaic element comprises one or more photovoltaic panels suitable for being associated with an upper portion of the car seat 20, preferably in a rear position thereof, opposite with respect to a portion intended to receive the head of a child so as to receive solar radiation entering the vehicle 60 through windows and rear window.

Alternative embodiments (not shown) may not have the electric battery. In such case, the electric energy for the operation of the sensor arrangement and for the communication arrangement is completely provided by the energy harvesting module.

Optionally, the energy arrangement 50 may comprise an electric coupling module (not shown in the drawings), which allows electrically coupling the energy arrangement 50 to the energy supply circuit 63 of the vehicle 60 to receive a respective supply energy. In particular, the electric coupling module comprises an electric cable adapted to be connected to a wiring of the supply circuit 63 positioned in the rear part of the vehicle 60 to supply electric, electronic and/or electromechanical elements (for example, lamps, cameras, proximity sensors, etc.) located in such rear part of the vehicle 60. Preferably, the electric cable of the electric coupling module is suitable for being coupled to a power receptacle (indicated also as lighter holder) placed at a rear part of the passenger compartment.

Thereby, it is possible to ensure the possibility of supplying the sensor arrangement 30 and/or the transmitter module 43 of the communication arrangement 40 in conditions of breakdown of the electric battery 53 and/or of the energy harvesting module 56. Moreover, the electric coupling module may be configured to allow a quick recharging of the electric battery 53.

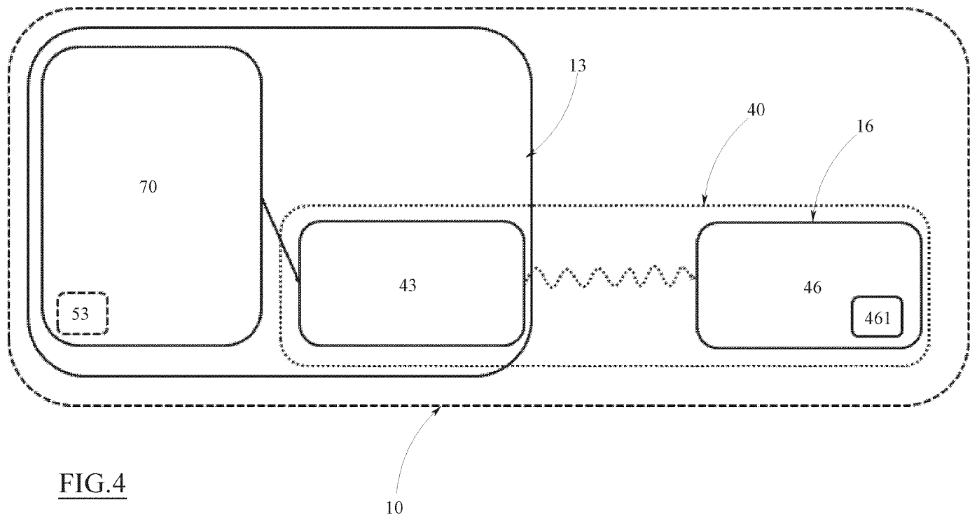

In an alternative embodiment (shown in FIG. 4), the sensor arrangement 30 and the energy arrangement 50 may correspond. Advantageously, the sensor arrangement 30 and the energy arrangement 50 may be implemented as an autonomous sensor arrangement 70. In detail, the autonomous sensor arrangement 70 comprises the energy module 56 which is used as (pressure) sensor for detecting the presence of a child in the car seat 20 in addition to generating electric energy.

For example, the generation of electric energy, preferably greater than a threshold value, by means of the piezoelectric element of the energy harvesting module 56, may be associated with the presence of a body (i.e., the child) in the car seat 20. A sensor circuitry of the autonomous sensor arrangement may generate the corresponding indicative signal Sr when the generation of electric energy is detected, while a supply circuitry supplies energy to the transmitter module 43.

More preferably, the same electric energy provided by the autonomous sensor arrangement 70 to the transmitter module 43 may be interpreted by the latter as the indicative signal Sr (thus simplifying the structure of the device 10). In other words, the transmitter module 43 is configured to generate the warning signal Sa when it is supplied by the electric energy generated by the piezoelectric element of the energy harvesting module 56.

As is apparent to those skilled in the art, in the example in the drawings, the device 10 comprises two separate and distinct components: a seat component 13 and a receiver component 16. The seat component 13 comprises the sensor arrangement 30, the transmitter module 43 of the communication arrangement 40 and the energy arrangement 50, while the receiver component 16 comprises the receiver module 46 of the communication arrangement 40.

In one embodiment of the present invention, at least one portion of the seat component 13—comprising at least the pressure sensor of the sensor arrangement 30 and the piezoelectric element of the energy harvesting module 56—is suitable for being associated with a seat 21 of the car seat 20. Preferably, the portion of the seat component 13 of the device 10 is suitable for being housed between a structure of the car seat 20 and a covering thereof (not detailed in the drawings).

In the embodiment in FIG. 4, only the piezoelectric element of the energy harvester 56 can be associated with the seat 21 of the car seat 20 because the piezoelectric element operates also as sensor in addition to energy generator.

In particular, the sensor arrangement 30, and preferably the piezoelectric element, are integrated in a substantially flat support 19 having a surface substantially corresponding to a seat 21 of the car seat 20.

Advantageously, the support 19 is shaped so as not to reduce a comfort of the seat 21 of the car seat 20 (for example, preferably it has a substantially uniform thickness). In embodiments of the invention, the support may comprise a portion of fabric, an unwoven fabric, a plastically deformable sheet or a sheet made of elastic material. Differently, the remaining elements of the communication arrangement 40, the transmitter module 43 and the relative circuitry in the example considered, and the remaining elements of the energy arrangement 50, such as the electric battery 53 and relative circuitry, may be implemented in an assembly which is separate from the support and is electrically interconnected to the support, for example which are located in the part below the car seat 20 where a sufficient space to house such assembly is available (generally, a seat surface of the car seat 20 is usually raised by at least 10 centimetres from the seat surface of the seat of the vehicle 60 on which the car seat 20 is positioned).

In a preferred embodiment, the whole seat component 13 of the device 10 is suitable for being associated with a seat 21 of the car seat 20, preferably housed between a structure of the car seat 20 and a covering thereof. Preferably, the whole seat component 13 of the device 10 is entirely implemented in the support 19 mentioned above.

In light of that described above, the operation of the device 10 is the following.

The device 10 is positioned in the operating position thereof in the car seat 20, i.e. preferably the support of the seat component 13 is arranged between the structure and the cover of the car seat 20, while the receiver component 16, that is the receiver module 46 and the relative receiver circuitry, is operatively coupled to the BUS 61 of the vehicle 60, as described above.

When a body is positioned, in particular when a child is placed in the car seat 20, the sensor arrangement 30 detects the presence thereof and generates the corresponding signal Sr indicative of the detection of the body. The indicative signal Sr is transferred to the communication arrangement 40, to the transmitter module 43 in the example considered, where it is converted into the corresponding warning signal Sa. The transmitter module 43 may emit the warning signal Sa in a continuous matter, periodically and/or at random time intervals.

If the sensor arrangement 30 comprises a pressure sensor with a switch, the beginning of the transfer of energy from the energy arrangement 50 to the communication arrangement 40 corresponds to the indicative signal Sr. In other words, in the case of sensor arrangement 30 comprising a switch pressure sensor, the transmitter module 43 is configured to generate and transmit the signal Sa when it is powered.

At the same time, the energy harvesting module 56 of the energy arrangement 50 generates electric energy which may be stored in the electric battery 53 and/or may be directly absorbed by the sensor arrangement 30 and/or by the communication arrangement 40. For example, in the case of energy harvesting module 56 comprising the piezoelectric element, the latter converts vibrations due to the operation of the vehicle 60 and the movements of the child in the car seat 20 into electric energy which can be stored in the electric battery 53 and/or exploited by the sensor arrangement 30 and/or by the communication arrangement 40.

In the case of the alternative embodiment of FIG. 4, the movements of a child in the car seat 20 activate the generation of energy by the piezoelectric element. Advantageously, the electric energy supplied by the autonomous sensor arrangement 70 to the transmitter module 43 is also interpreted as indicative signal Sr. In other words, an electric energy generated by the piezoelectric element of the energy harvester 56 indicates a body interacting with such piezoelectric element.

The receiver module 46 receives the warning signal Sa, possibly, the reception of the warning signal Sa may be stored in a memory element (not illustrated) comprised in the receiver circuitry.

When the receiver module 46 receives the power-down signal Sv from the engine control unit 62 of the vehicle 60, the receiver module 46 may generate an emergency warning command and/or an alarm for reminding the driver of the vehicle 60 of the presence of the child.

Preferably, the receiver module 46 is configured to actuate the buzzer 461 following the reception both of the warning signal Sa and the vehicle power-down signal Sv.

Alternatively or additionally, the receiver module 46 is configured to generate one or more emergency warning commands C and to send it to one or more electronic control units which control respective elements of the vehicle 60, such as for example an ECU 64 for controlling lamps (headlamps and/or indicators), an ECU 65 for controlling an acoustic indicator, or hooter, an ECU 66 for controlling window winders, an ECU 67 for controlling a ventilation circuit (and possibly the engine control unit 62 of the vehicle 60) following the receipt both of the warning signal Sa and of the vehicle power-down signal Sv.

For this purpose, the receiver circuitry may comprise one or more adequate processing elements, such as for example a microprocessor, a microcontroller, a processor of digital signals and/or of other electronic components.

In detail, the receiver module 46 generates one or more emergency warning commands C which are transferred to the elements of the vehicle 60 by means of the BUS 61 to actuate an emergency warning procedure.

Preferably, the emergency warning procedure implements one or more actions for attracting the attention of the driver (and possible other individuals close to the vehicle 60) and/or implements one or more emergency measures for protecting the child in the car seat 20.

In one embodiment, the one or more emergency warning commands C comprise at least one among:
an actuation command of a lamp of the vehicle 60, such as headlamps or indicators, sent to the ECU 64;
an actuation command of the hooter of the vehicle 60, sent to the ECU 65 or a radio;
an actuation command of a window winder sent to the ECU 66 for opening at least one window of the vehicle 60, and
an actuation command of a ventilation circuit sent to the ECU 67 of the vehicle 60, for example to introduce external air into a passenger compartment of the vehicle 60.

Preferably, the receiver module 46 is configured to delay, by a predetermined time interval 6t, transmitting the one or more emergency warning commands C and/or actuating the buzzer 461 starting from the receipt of the vehicle power-down signal Sv. In other words, the receiver module 46 may be configured to transmit the one or more emergency warning commands C and/or to actuate the buzzer 461 after a time interval 6t from the receipt of the signal Sv conditionally to the receipt of the warning signal Sa.

Advantageously, if the transmitter module 43 in the seat component 13 stops sending the warning signal Sa during the time interval 6t, the sending of the one or more commands C is cancelled. Indeed, a removal of the body from the support comprising the pressure sensor of the sensor arrangement 30, that is a movement of the child from the car seat 20, results in an interruption of the detection of the body and therefore the transmission of the warning signal Sa is interrupted. In other words, when the child leaves the car seat 20 within the time interval 6t, the emergency warning procedure and/or acoustic signalling are cancelled.

The invention thus conceived is susceptible to several modifications and variations, all falling within the scope of the inventive concept.

For example, two time intervals may be defined, once a first time interval has lapsed from the receipt of the vehicle power-down signal Sv, the acoustic signal of the receiver module 46 is activated, while once a second time interval has lapsed (greater than the first time interval), the one or more emergency warning commands C are transmitted through the BUS 61.

In one embodiment, the whole seat component 13 of the device 10 may be formed integrally with a car seat. In other words, the car seat may comprise one or more housings in which the sensor arrangement 30, the transmitter module 43 of the communication arrangement 40 and the energy arrangement 50 of the seat component are arranged during a step of manufacturing or assembling the same.

Moreover, all the details can be replaced by other technically equivalent elements.

Practically, any materials and also any contingent shapes and sizes may be used, depending on the needs, without departing from the scope of protection of the following claims.

1-15. (canceled)

16. A device adapted to detect the presence of a child in a car seat of a vehicle and to generate an emergency warning, the device comprising:
a sensor arrangement that can be operatively coupled to the car seat, the sensor arrangement being adapted to detect a body interacting therewith and to generate a signal indicative of the detection thereof;
a communication arrangement comprising a transmitter module coupled to the sensor arrangement and a receiver module that can be coupled to an engine control unit of the vehicle through a communication interface of the vehicle on which the car seat is mounted to receive and to transmit signals to the engine control unit, and
an energy arrangement operatively connected to the sensor arrangement and to the transmitter module of the communication arrangement and suitable for providing electric energy thereto,
characterized in that the sensor arrangement and the energy arrangement correspond.

17. The device according to claim 16, wherein the energy arrangement comprises an energy harvesting module, the energy harvesting module comprises a piezoelectric element converting vibrations due to the operation of the vehicle and the movements of the child in the car seat into electric energy, the piezoelectric element being comprised in the sensor arrangement, an electric energy generated by the piezoelectric element indicating a body interacting therewith.

18. The device according to claim 17 wherein the energy arrangement comprises an electric battery.

19. The device according to claim 18, wherein the energy harvesting module is operatively connected to the electric battery to provide electric energy thereto.

20. The device according to claim 19, further comprising a flat support having a surface corresponding to a seat of the car seat, and wherein the sensor arrangement and the piezoelectric element are integrated in the support.

21. The device according to claim 18, wherein the energy harvester comprises a photovoltaic element.

22. The device according to claim 16, wherein the transmitter module is suitable for transmitting radiofrequency signals to the receiver module.

23. The device according to claim 22, wherein the receiver module comprises an acoustic indicator.

24. The device according to claim 16, wherein the receiver module is configured to generate an emergency warning command and to send such command to an electronic control unit of an element of the vehicle through the communication interface thereof following the receipt both of a warning signal transmitted by the transmitter module and a vehicle power-down signal transmitted by an engine control unit of the vehicle.

25. The device according to claim 24, wherein the receiver module is configured to delay, by a predetermined time interval, sending the emergency warning command and/or actuating the acoustic indicator starting from the receipt of the vehicle power-down signal.

26. The device according to claim 24, wherein the emergency warning command comprises at least one among:
an actuation command of a lamp of the vehicle;
an actuation command of an acoustic indicator of the vehicle;
an actuation command of a window winder for opening a window of the vehicle;
an actuation command of a ventilation circuit of the vehicle.

27. A method for detecting the presence of a child in a car seat of a vehicle and for generating an emergency warning, comprising the steps of:
providing a device according to claim 16;
detecting the presence of a child in the car seat through the sensor arrangement;
generating a corresponding signal indicative of the detection of the child in the car seat;
transferring the indicative signal to the transmitter module of the communication arrangement;
converting the indicative signal into a corresponding warning signal;
generating an emergency warning command when the receiver module of the communication arrangement receives a power-down signal from the engine control unit of the vehicle and a warning signal from the transmitter module.
